(19) United States
(12) Patent Application Publication
(10) Pub. No.: US 2025/0243433 A1
(43) Pub. Date: Jul. 31, 2025

(54) FABRIC RINSE FORMULATION WITH AMINO ACID CHLORINE SCAVENGER

(71) Applicant: Henkel AG & Co. KGaA, Duesseldorf (DE)

(72) Inventor: Daniel Thomas Piorkowski, Fairfield, CT (US)

(21) Appl. No.: 18/986,030

(22) Filed: Dec. 18, 2024

Related U.S. Application Data
(60) Provisional application No. 63/619,414, filed on Jan. 10, 2024.

(51) Int. Cl. C11D 3/33; C11D 3/00; C11D 3/10; C11D 3/20

(52) U.S. Cl. CPC C11D 3/33; C11D 3/0015; C11D 3/10; C11D 3/2086

(57) ABSTRACT

A fabric rinse formulation (unitized or non-unitized format) that contains an amino acid chlorine scavenger, such as lysine, is provided. The fabric rinse formulation contains at least one amino acid and optionally a fabric specific agent in aqueous solution. The fabric rinse formulation (unitized or non-unitized format) can be used during or after the washing or softening of fabrics to reduce or prevent problems associated with laundering of fabrics in a chlorine-containing water source. Notably, the fabric rinse formulation (unitized or non-unitized format) can reduce or even eliminate dye deterioration.

### CROSS REFERENCE TO RELATED APPLICATION

The present invention claims the benefit of U.S. Provisional Patent Application No. 63/619,414 filed Jan. 10, 2024, the entire content and disclosure of which is incorporated herein by reference.

### BACKGROUND

The present disclosure generally relates to fabric laundering, and more particularly to a fabric rinse formulation (unitized or non-unitized format) that contains an amino acid functioning as a chlorine scavenger and a method of using the same.

In some areas, such as, for example, industrialized cities and towns, the water used for laundering fabrics contains chlorine. Chlorine is used in water sources as a sanitization agent against microbes so as to render the water potable/drinkable. Chlorine is known to deteriorate fabric dyes over time, especially when red, blue or black dyes are used. If not controlled, dye deterioration may be seen in 3 to 30 washes. In addition to dye damage, chlorine in the water source can negatively impact enzyme performances for cleaning.

In view of the above, there is a need for formulations and methods for reducing or preventing the adverse effects of chlorine in water used for washing or otherwise treating fabrics.

### SUMMARY

A fabric rinse formulation (unitized or non-unitized format) that contains an amino acid as a chlorine scavenger is provided. The fabric rinse formulation contains (i.e., comprises, consists essentially of, or consists of) at least one amino acid and optionally at least one fabric specific agent and/or pH adjusting compound and/or surfactant in aqueous solution. The pH of the fabric rinse formulation is typically within a range of 2 to 11.5. The pH may be in a more specific range of, for example, 2.3-2.9, 6-8, or 10.3-11.3. The fabric specific agent may be, for example, a fabric conditioning agent (e.g., softening agent), fragrance component, or colorant. In some embodiments, the fabric rinse formulation further contains a thickening agent, a non-ionic surfactant, or one or more pH adjusting compounds (e.g., an acid or base).

The amino acid in the rinse aid may be selected from, for example, alanine, arginine, asparagine, aspartate, cysteine, glutamine, glutamate, glycine, histidine, isoleucine, leucine, lysine, methionine, phenylalanine, proline, serine, threonine, tryptophan, tyrosine, valine, and unnatural amino acids, or the amino acid may be a combination of any two or more of the foregoing amino acids. In some embodiments, the amino acid contains an amino-containing side chain, such as found in lysine. In some embodiments, the fabric rinse formulation includes lysine, either as a sole amino acid or in combination with one or more other amino acids. In some embodiments, the fabric rinse formulation includes lysine and/or threonine. In some embodiments, any one or more of the above amino acids, except for lysine and/or threonine, may be excluded from the fabric rinse formulation.

In another aspect, the present disclosure is directed to a method of using the above described rinse aid formulation. The rinse aid formulation (unitized or non-unitized format) can be used after the washing of fabrics, and possibly in place of or combined with an after-washing softening treatment, to reduce or even eliminate the problems associated with laundering of fabrics in a chlorine containing water source. In some embodiments, the fabric is treated with the rinse aid formulation as a final treatment of the fabric after washing and optional softening, before the fabric is dried. In embodiments, the rinse aid formulation (unitized or non-unitized format) can reduce or even eliminate dye deterioration, without negatively impacting enzyme performance for cleaning.

### DETAILED DESCRIPTION

The present disclosure will now be described in greater detail by referring to the following discussion and drawings that accompany the present disclosure. In the following description, numerous specific details are set forth, such as particular structures, components, materials, dimensions, processing steps and techniques, in order to provide an understanding of the various embodiments of the present disclosure. However, it will be appreciated by one of ordinary skill in the art that the various embodiments of the present disclosure may be practiced without these specific details. As used throughout the present disclosure, the term “about” generally indicates no more than ±10%, ±5%, ±2%, ±1% or ±0.5% from a number. When a range is expressed in the present disclosure as being from one number to another number (e.g., 20 to 40), the present disclose contemplates any numerical value that is within the range (i.e., 22, 24, 26, 28.5, 31, 33.5, 35, 37.7, 39 or 40) or any in amount that is bounded by any of the two values that can be present within the range (e.g., 28.5-35).

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising”, when used in this disclosure, specify the presence of stated features, integers, steps, operations, elements, and/or components, but do not preclude the presence or addition of one or more other features, integers, steps, operations, elements, components, and/or groups thereof.

### Rinse Aid Formulation

The present disclosure provides a fabric rinse aid formulation that includes (i.e., comprises, consists essentially of, or consists of) an amino acid in aqueous solution. The term “unitized,” as used herein, indicates a single dosed mass or volume of the rinse aid formulation, which may alternatively be referred to as a “pod”. The term “fabric,” as used herein, generally refers to an object constructed of fibers, such as clothing and other apparel meant to be worn by or provide physical comfort or utility to a user, more commonly referred to as “laundry”. Nevertheless, in some embodiments, the term “fabric” may include materials not meant to be worn by or provide physical comfort or utility to a user, such as decorative items, e.g., flags or banners, or household functional items, such as place mats. The fabric may be woven or non-woven. The fabric may be formed of any suitable fibers known in the art, such as cotton, polyester, rayon, nylon, spandex, or wool, or a combination of two or more of these. In some embodiments, any one or more of the foregoing types of fabrics may be excluded.

The fabric rinse formulation preferably has a pH within a range of 2-11.5. The pH may be precisely or about, for example, 2, 2.3, 2.5, 2.8, 2.9, 3, 3.5, 4, 4.5, 5, 5.5, 6, 6.5, 7, 7.5, 8, 8.5, 9, 9.5, 10, 10.3, 10.5, 11, 11.3, or 11.5, or the pH may be within a range bounded by any two of the foregoing values, e.g., 2-11.5, 2-11.3, 2-8, 2-6, 2-4, 2-3, 2-2.9, 2-2.5, 3-11.5, 3-11.3, 3-8, 3-6, 3-4, 4-11.5, 4-11.3, 4-8, 4-6, 5-11.5, 5-11.3, 5-8, 6-11.5, 6-11.3, 6-11, 6-8, 7-11.5, 7-11.3, 7-11, 7-10, 7-9, 7-8, 8-11.5, 8-11.3, 8-11, 8-10, 8-9, 9-11.5, 9-11.3, 9-11, 9-10, 10-11.5, 10-11.3, 10-11, 10.3-11.5, 10.3-11.3, 10.3-11, 10.5-11.5, 10.5-11.3, or 10.5-11.

In some embodiments, the fabric rinse formulation includes one or more additional components suited for fabrics, such as one or more of a colorant, dispersant, fragrance, enzyme, bleach, filler, dye, an alcoholic solvent, or the like. The alcoholic solvent may be, for example, ethanol, or a glycol, such as, for example, propylene glycol, dipropylene glycol, glycerol, or a combination thereof. The alcoholic solvent may be present in the salt or base in an amount from about 0% to about 5.0%, from above 0% to about 2.0%, from above 0% to about 1.0%. In some embodiments, the fabric rinse formulation excludes any one or more of the above components.

### Amino Acids

The amino acid may be any one or more amino acids known in the art. In some embodiments, the one or more amino acids contain an amino-containing side chain (e.g., lysine). Some examples of amino acids include alanine, arginine, asparagine, aspartate, cysteine, glutamine, glutamate, glycine, histidine, isoleucine, leucine, lysine, methionine, phenylalanine, proline, serine, threonine, tryptophan, tyrosine, valine, and unnatural amino acids. Combinations of one or more amino acids of any of the foregoing amino acids may also be used. In some embodiments, the amino acid is or includes lysine, wherein lysine may be used as the sole amino acid in admixture with one or more other amino acids. In some embodiments, the amino acid is or includes threonine, wherein threonine may be used as the sole amino acid in admixture with one or more other amino acids. In some embodiments, the amino acid is or includes at least one of lysine and threonine, or both. The amino acid(s) can be in any stereoisomeric configuration (i.e., the D or L form).

In one embodiment, the amino acid is present in the fabric rinse formulation in an amount from about 0.01 percent by weight to about 10.0 percent by weight based on the total weight of the formulation. In another embodiment, the amino acid is present in an amount from about 0.02 percent by weight to about 5.0 percent by weight based on the total weight of the formulation. In yet another embodiment, the amino acid is present in an amount from about 1 percent by weight to about 3.0 percent by weight based on the total weight of the formulation. In various embodiments, the amino acid is present in the rinse formulation in an amount of precisely or about, for example, 0.01, 0.02, 0.05, 0.1, 0.15, 0.2, 0.5, 1, 2, 4, 5, 6, 7, 8, 9, or 10 wt %, or in an amount within a range bounded by any two of the foregoing values, e.g., 0.01-10 wt %, 0.1-10 wt %, 0.5-10 wt %, 1-10 wt %, 0.01-5 wt %, 0.1-5 wt %, 0.5-5 wt %, 1-5 wt %, 0.01-2 wt %, 0.1-2 wt %, 0.5-2 wt %, 1-2 wt %, 0.01-1 wt %, 0.1-1 wt %, 0.5-1 wt %, 0.01-0.5 wt %, 0.1-0.5 wt %, 0.01-0.2 wt %, or 0.1-0.2 wt %.

### Fabric Specific Agent

In some embodiments, the fabric rinse formulation further includes a fabric specific agent. The fabric specific agent is any agent that is specifically useful or beneficial in the washing or treating of fabrics. The fabric specific agent may be, for example, a fabric conditioning agent (e.g., a fabric softening agent), fragrance component, or colorant. In some embodiments, a fabric conditioning agent is excluded from the fabric rinse formulation. In some embodiments, a softening agent is excluded from the fabric rinse formulation. In some embodiments, a fabric specific agent is not present in the fabric rinse formulation, in which case the fabric rinse formulation may be composed, at minimum, of an aqueous solution of an amino acid (such as any one or more provided earlier above), and optionally, one or more pH adjusting agents.

One or more fabric softening agents may or may not be present in the fabric rinse formulation. If present, the one or more fabric softening agents may be selected from among any of the compounds well known in the art that provide a fabric softening property to fabrics. As well known, the fabric softening agent may be a cationic or anionic compound or polymer. A particular class of cationic softening agents include the ammonium-based surfactants, such as the esterquats. Some particular classes of anionic softening agents include the sulfonic acid and phosphonic acid surfactants. In some embodiments, one or more cationic or anionic compounds or polymers are excluded from the fabric rinse formulation.

A fragrance component that provides malodor reduction/elimination and a fresh scent to laundered fabrics may or may not be present in the fabric rinse formulation of the present disclosure. In one aspect, the fragrance component can be a free fragrance, a fragrance precursor, a solid particulate containing at least one fragrance and a fragrance carrier (i.e., a fragrance booster), an encapsulated fragrance, or any combination thereof. In some embodiments, the fabric rinse formulation excludes a fragrance (i.e., is fragrance free).

In one aspect, the fragrance has a melting point that is in the range of from about −100° C. to about 100° C., or from about −80° C. to 80° C., or from about −20° C. to about 50° C., or from about −30° C. to about 20° C. In one aspect, the fragrance can have a melting point that is in the range of from about 25° C. to about 400° C., or from about 50° C. to about 380° C., or from about 75° C. to about 350° C., or from about 100° C. to about 330° C.

In some embodiments, the fragrance is an ester, an ether, an aldehyde, a ketone, an alcohol, a hydrocarbon, an essential oil, and a combination thereof. In one aspect, the fragrance can be, for example, adoxal (2,6,10-trimethyl-9-undecenal), anisaldehyde (4-methoxybenzaldehyde), cymal (3-(4-isopropyl-phenyl)-2-methylpropanal), ethylvanillin, florhydral (3-(3-isopropylphenyl)butanal), helional (3-(3,4-methylenedioxyphenyl)-2-methylpropanal), heliotropin, hydroxycitronellal, lauraldehyde, lyral (3- and 4-(4-hydroxy-4-methylpentyl)-3-cyclohexene-1-carboxaldehyde), methyl nonyl acetaldehyde, lilial (3-(4-tert-butylphenyl)-2-methylpropanal), phenyl acetaldehyde, undecylenaldehyde, vanillin, 2,6,10-trimethyl-9-undecenal, 3-dodecen-1-al, α-n-amylcinnamaldehyde, melonal (2,6-dimethyl-5-heptenal), 2,4-dimethyl-3-cyclohexene-1-carboxaldehyde (triplal), 4-methoxybenzaldehyde, benzaldehyde, 3-(4-tert-butylphenyl) propanal, 2-methyl-3-(para-methoxyphenyl) propanal, 2-methyl-4-(2,6,6-timethyl-2 (1)-cyclohexen-1-yl)butanal, 3-phenyl-2-propenal, cis-/trans-3,7-dimethyl-2,6-octadien-1-al, 3,7-dimethyl-6-octen-1-al, [(3,7-dimethyl-6-octenyl)oxy]acetaldehyde, 4-isopropylbenzylaldehyde, 1,2,3,4,5,6,7,8-octahydro-8,8-dimethyl-2-naphthaldehyde, 2,4-dimethyl-3-cyclohexene-1-carboxaldehyde, 2-methyl-3-(isopropylphenyl)propanal, 1-decanal, 2,6-dimethyl-5-heptenal, 4-(tricyclo[5.2.1.0 (2,6)]decylidene-8)butanal, octahydro-4,7-methano-1H-indenecarboxaldehyde, 3-ethoxy-4-hydroxybenzaldehyde, para-ethyl-α,α-dimethylhydrocinnamaldehyde, α-methyl-3,4-(methylenedioxy)hydrocinnamaldehyde, 3,4-methylenedioxybenzaldehyde, α-n-hexylcinnamaldehyde, m-cymene-7-carboxaldehyde, α-methyl phenylacetaldehyde, 7-hydroxy-3,7-dimethyloctanal, undecanal, 2,4,6-trimethyl-3-cyclohexene-1-carboxaldehyde, 4-(3)(4-methyl-3-pentenyl)-3-cyclohexenecarboxaldehyde, 1-dodecanal, 2,4-dimethylcyclohexene-3-carboxaldehyde, 4-(4-hydroxy-4-methylpentyl)-3-cylohexene-1-carboxaldehyde, 7-methoxy-3,7-dimethyloctan-1-al, 2-methylundecanal, 2-methyldecanal, 1-nonanal, 1-octanal, 2,6,10-trimethyl-5,9-undecadienal, 2-methyl-3-(4-tert-butyl) propanal, dihydrocinnamaldehyde, 1-methyl-4-(4-methyl-3-pentenyl)-3-cyclohexene-1-carboxaldehyde, 5- or 6-methoxyhexahydro-4,7-methanoindane-1- or −2-carboxaldehyde, 3,7-dimethyloctan-1-al, 1-undecanal, 10-undecen-1-al, 4-hydroxy-3-methoxybenzaldehyde, 1-methyl-3-(4-methylpentyl)-3-cyclohexenecarboxaldehyde, 7-hydroxy-3J-dimethyloctanal, trans-4-decenal, 2,6-nonadienal, para-tolylacetaldehyde, 4-methylphenylacetaldehyde, 2-methyl-4-(2,6,6-trimethyl-1-cyclohexen-1-yl)-2-butenal, ortho-methoxycinnamaldehyde, 3,5,6-trimethyl-3-cyclohexene-carboxaldehyde, 3J-dimethyl-2-methylene-6-octenal, phenoxyacetaldehyde, 5,9-dimethyl-4,8-decadienal, peony aldehyde (6,10-dimethyl-3-oxa-5,9-undecadien-1-al), hexahydro-4,7-methanoindane-1-carboxaldehyde, 2-methyloctanal, α-methyl-4-(1-methylethyl)benzene acetaldehyde, 6,6-dimethyl-2-norpinene-2-propionaldehyde, para-methylphenoxyacetaldehyde, 2-methyl-3-phenyl-2-propen-1-al, 3,5,5-trimethylhexanal, hexahydro-8,8-dimethyl-2-naphthaldehyde, 3-propyl-bicyclo-[2.2.1]-hept-5-ene-2-carbaldehyde, 9-decenal, 3-methyl-5-phenyl-1-pentanal, methyl nonyl acetaldehyde, hexanal, or trans-2-hexenal, or a combination of two or more of these.

In other embodiments, the fragrance is, for example, methyl β-naphthyl ketone, musk indanone (1,2,3,5,6,7-hexahydro-1,1,2,3,3-pentamethyl-4H-inden-4-one), tonalide (6-acetyl-1,1,2,4,4,7-hexamethyltetralin), α-damascone, β-damascone, Δ-damascone, iso-damascone, damascenone, methyl dihydrojasmonate, menthone, carvone, camphor, koavone (3,4,5,6,6-pentamethylhept-3-en-2-one), fenchone, α-ionone, β-ionone, γ-methyl ionone, fleuramone (2-heptylcyclopentanone), dihydrojasmone, cis-jasmone, Iso E Super (1-(1,2,3,4,5,6J,8-octahydro-2,3,8,8-tetramethyl-2-naphthalenyl)ethan-1-one (and isomers)), methyl cedrenyl ketone, acetophenone, methyl acetophenone, para-methoxyacetophenone, methyl β-naphtyl ketone, benzyl acetone, benzophenone, para-hydroxyphenylbutanone, celery ketone (3-methyl-5-propyl-2-cyclohexenone), 6-isopropyldecahydro-2-naphtone, dimethyl octenone, frescomenthe (2-butan-2-ylcyclohexan-1-one), 4-(1-ethoxyvinyl)-3,3,5,5-tetramethylcyclohexanone, methyl heptenone, 2-(2-(4-methyl-3-cyclohexen-1-yl) propyl)cyclopentanone, 1-(p-menthen-6(2)yl)-1-propanone, 4-(4-hydroxy-3-methoxyphenyl)-2-butanone, 2-acetyl-3,3-dimethylnorbornane, 6,7-dihydro-1,1,2,3,3-pentamethyl-4(5H)indanone, 4-damascol, dulcinyl(4-(1,3-benzodioxol-5-yl)butan-2-one), Hexalon (1-(2,6,6-trimethyl-2-cyclohexen-1-yl)-1,6-heptadien-3-one), isocyclemone E (2-acetonaphthone-1,2,3,4,5,6,7,8-octahydro-2,3,8,8-tetramethyl), methyl nonyl ketone, methyl cyclocitrone, methyl lavender ketone, orivone (4-tert-amylcyclohexanone), 4-tert-butylcyclohexanone, delphone (2-pentyl cyclopentanone), muscone (CAS 541-91-3), neobutenone (1-(5,5-dimethyl-1-cyclohexenyl)pent-4-en-1-one), plicatone (CAS 41724-19-0), veloutone (2,2,5-trimethyl-5-pentylcyclopentan-1-one), 2,4,4,7-tetramethyloct-6-en-3-one, or tetrameran (6,10-dimethylundecen-2-one), or a combination of two or more of these.

In other embodiments, the fragrance is, for example, 10-undecen-1-ol, 2,6-dimethylheptan-2-ol, 2-methylbutanol, 2-methylpentanol, 2-phenoxyethanol, 2-phenylpropanol, 2-tert-butylcyclohexanol, 3,5,5-trimethylcyclohexanol, 3-hexanol, 3-methyl-5-phenylpentanol, 3-octanol, 3-phenylpropanol, 4-heptenol, 4-isopropylcyclohexanol,4-tert-butylcyclohexanol, 6,8-dimethyl-2-nonanol, 6-nonen-1-ol, 9-decen-1-ol, α-methylbenzyl alcohol, α-terpineol, amyl salicylate, benzyl alcohol, benzyl salicylate, 8-terpineol, butyl salicylate, citronellol, cyclohexyl salicylate, decanol, dihydromyrcenol, dimethyl benzyl carbinol, dimethyl heptanol, dimethyl octanol, ethyl salicylate, ethyl vanillin, eugenol, farnesol, geraniol, heptanol, hexyl salicylate, isoborneol, isoeugenol, isopulegol, linalool, menthol, myrtenol, n-hexanol, nerol, nonanol, octanol, p-menthan-7-ol, phenylethyl alcohol, phenol, phenyl salicylat, tetrahydrogeraniol, tetrahydrolinalool, thymol, trans-2-cis-6-nonadicnol, trans-2-nonen-1-ol, trans-2-octenol, undecanol, vanillin, champiniol, hexenol, cinnamyl alcohol, or a combination of two or more of these.

In other embodiments, the fragrance is, for example, benzyl acetate, phenoxyethyl isobutyrate, p-tert-butylcyclohexyl acetate, linalyl acetate, dimethyl benzyl carbinyl acetate (DMBCA), phenyl ethyl acetate, benzyl acetate, ethylmethylphenyl glycinate, allyl cyclohexyl propionate, styralyl propionate, benzyl salicylate, cyclohexyl salicylate, floramat, melusat, or jasmacyclat, or a combination of two or more of these.

In other embodiments, the fragrance is, for example, benzyl ethyl ether and ambroxan. The hydrocarbons include mainly terpenes, such as limonene and pinene.

In other embodiments, the fragrance is a mixture of various fragrances, which can be referred to as a perfume or perfume oil. Perfume oils of this kind can also contain natural fragrance mixtures, as are obtainable from plant sources.

In other embodiments, the fragrance is, for example, one or more essential oils, such as angelica root oil, anise oil, arnica blossom oil, basil oil, bay oil, champaca blossom oil, citrus oil, silver fir oil, silver fir cone oil, elemi oil, eucalyptus oil, fennel oil, pine needle oil, galbanum oil, geranium oil, ginger grass oil, guaiac wood oil, gurjun balsam oil, helichrysum oil, ho oil, ginger oil, iris oil, jasmine oil, cajeput oil, calamus oil, chamomile oil, camphor oil, canaga oil, cardamom oil, cassia oil, pine needle oil, copaiba balsam oil, coriander oil, spearmint oil, caraway oil, cumin oil, labdanum oil, lavender oil, lemongrass oil, lime blossom oil, lime oil, mandarin oil, balm oil, mint oil, musk seed oil, muscatel oil, myrrh oil, clove oil, neroli oil, niaouli oil, olibanum oil, orange blossom oil, orange oil, origanum oil, palmarosa oil, patchouli oil, peru balsam oil, petitgrain oil, pepper oil, peppermint oil, pimento oil, pine oil, rose oil, rosemary oil, sage oil, sandalwood oil, celery oil, spike oil, star anise oil, turpentine oil, thuja oil, thyme oil, verbena oil, vetiver oil, juniper berry oil, wormwood oil, wintergreen oil, ylang-ylang oil, hyssop oil, cinnamon oil, cinnamon leaf oil, citronella oil, lemon oil and cypress oil and ambrettolide, ambroxan, α-amylcinnamaldehyde, anethol, anisaldehyde, anise alcohol, anisol, anthranilic acid methyl ester, acetophenone, benzyl acetone, benzaldehyde, benzoic acid ethyl ester, benzophenone, benzyl alcohol, benzyl acetate, benzyl benzoate, benzyl formate, benzyl valerianate, borneol, bornyl acetate, boisambrene forte, α-bromostyrene, n-decyl aldehyde, n-dodecyl aldehyde, eugenol, eugenol methyl ether, eucalyptol, farnesol, fenchone, fenchyl acetate, geranyl acetate, geranyl formate, heliotropin, heptine carboxylic acid methyl ester, heptaldehyde, hydroquinone dimethyl ether, hydroxycinnamaldehyde, hydroxycinnamyl alcohol, indol, irone, isoeugenol, isoeugenol methyl ether, isosafrole, jasmone, camphor, carvacrol, carvone, p-cresol methyl ether, cumarin, p-methoxyacetophenone, methyl n-amyl ketone, methyl anthranilic acid methyl ester, p-methyl acetophenone, methyl chavicol, p-methyl quinoline, methyl β-naphthyl ketone, methyl n-nonyl acetaldehyde, methyl n-nonyl ketone, muscone, β-naphthol ethyl ether, β-naphthol methyl ether, nerol, n-nonyl aldehyde, nonyl alcohol, n-octyl aldehyde, p-oxy-acetophenone, pentadecanolide, β-phenyl ethyl alcohol, phenyl acetic acid, pulegone, safrole, salicylic acid isoamyl ester, salicylic acid methyl ester, salicylic acid hexyl ester, salicylic acid cyclohexyl ester, santalol, sandelice, skatole, terpineol, thymene, thymol, troenan, γ-undelactone, vanillin, veratrum aldehyde, cinnmaldehyde, cinnamyl alcohol, cinnamic acid, cinnamic acid ethyl ester, cinnamic acid benzyl ester, diphenyl oxide, limonene, linalool, linalyl acetate and propionate, melusat, menthol, menthone, methyl n-heptenone, pinene, phenyl acetaldehyde, terpinyl acetate, citral, citronellal, and mixtures thereof.

In other embodiments, the fragrance can have, for example, a musky scent, a pungent scent, a camphoraceous scent, an ethereal scent, a floral scent, a peppermint scent, or any combination thereof.

In other embodiments, the fragrance can comprise methyl formate, methyl acetate, methyl butyrate, ethyl butyrate, isoamyl acetate, pentyl butyrate, pentyl pentanoate, octyl acetate, myrcene, geraniol, nerol, citral, citronellol, linalool, nerolidol, limonene, camphor, terpineol, α-ionone, thujone, benzaldehyde, eugenol, cinnamaldehyde, ethyl maltol, vanillin, anisole, anethole, estragole, thymol, indole, pyridine, furaneol, 1-hexanol, cis-3-hexenal, furfural, hexyl cinnamaldehyde, fructone, hexyl acetate, ethyl methyl phenyl glycidate, dihydrojasmone, oct-1-en-3-one, 2-acetyl-1-pyrroline, 6-acetyl-2,3,4,5-tetrahydropyridine, γ-decalactone, γ-nonalactone, Δ-octalone, jasmine lactone, massoia lactone, wine lactone, sotolon, grapefruit mercaptan, methanthiol, methyl phosphine, dimethyl phosphine, nerolin, 2,4,6-trichloroanisole, or any combination thereof.

In other embodiments, the fragrance can comprise a linear terpene, a cyclic terpene, an aromatic compound, a lactone, a thiol, or any combination thereof.

In other embodiments, the fragrance can be a fragrance precursor. “Fragrance precursor” refers to compounds which only release the actual fragrance following chemical conversion/separation, for example, when exposed to light or other environmental conditions, such as pH, temperature, etc. Compositions of this kind are often referred to as pro-fragrances. In other embodiments, the fragrance component can be a free fragrance, a fragrance precursor, a fragrance booster, an encapsulated fragrance, or any combination thereof.

In some embodiments, the fragrance is an encapsulated fragrance with or without the fragrance booster. In embodiments, the encapsulated fragrance includes at least one fragrance encapsulated, for example, in a microcapsule or a nanocapsule. The microcapsules and nanocapsules can be water-soluble or water-insoluble. In one aspect, all of the fragrance is encapsulated. Examples of encapsulated fragrances are described in, for example, U.S. Pat. Nos. 6,024,943, 6,056,949, 6,194,375, 6,458,754 and 8,426,353, and US 2011/0224127 A1, each of which is incorporated by reference in its entirety. In some embodiments, an encapsulated fragrance is excluded from the fabric rinse formulation.

In one aspect, the fragrance component (e.g., fragrance booster and/or encapsulated fragrance) is present in the fabric rinse formulation in an amount from about 0.1 percent by weight to about 25.0 percent by weight, or from about 0.1 percent by weight to about 20 percent by weight, or from about 0.5 percent by weight to about 20 percent by weight, or from about 0.5 percent by weight to about 15 percent by weight, or from about 1 percent by weight to about 15 percent by weight, or from about 1 percent by weight to about 12 percent by weight, or from about 1.0 percent by weight to about 5% by weight, or from about 3 percent by weight to about 12 percent by weight, based on the total weight of the fabric rinse formulation.

In embodiments, the fabric rinse formulation of the present disclosure includes at least one colorant (dye). The colorant may be, for example, a water-soluble polymer, water-insoluble polymer, a water-soluble dye, a water-insoluble dye, or a combination thereof. The colorant(s) may be, for example, red, orange, yellow, blue, indigo, violet, or any combination thereof. In one aspect, the colorant(s) can be present in an amount of from about 0.0001% by weight to about 2.0% by weight, or from about 0.0001% by weight to about 1.5% by weight, or from about 0.0001% by weight to about 1.0% by weight, or from about 0.0001% by weight to about 0.5% by weight, or from about 0.001% by weight to about 0.3% by weight, or from about 0.001% by weight to about 0.1% by weight, or from about 0.001% by weight to about 0.05% by weight, or from about 0.001% by weight to about 0.025% by weight, or about 0.001% by weight, or about 0.002% by weight, or about 0.003% by weight, or about 0.0035% by weight of the composition. In some embodiments, the fabric rinse formulation excludes a colorant (i.e., is dye free).

### Optional Additional Agents or Compounds

The fabric rinse formulation of the present invention may also include one or more of the following optional additional agents: anti-foaming compounds, pH buffering agents, crystal growth inhibitors including carboxylic compounds, organic diphosphonic or monophosphonic acids, heavy metal ion sequestrants, including chelants and chlorine scavengers, hydrophobic dispersants, polymeric stabilizing agents, soil release polymers, preservatives, and/or anti-microbials. In embodiments, the fabric rinse formulation contains a thickening agent (e.g., glycerin, a polyalkylene glycol, or polyvinylalcohol). In embodiments, the fabric rinse formulation contains a non-ionic surfactant, such as a non-ionic fatty alcohol ethoxylate, alkyl phenol ethoxylate, or fatty acid alkoxylate. In embodiments, the fabric rinse formulation contains one or more pH adjusting compounds, which may be an acid (e.g., HCl, citric acid, or acetic acid) or base (NaOH or sodium carbonate). In other embodiments, any one or more of the above optional agents or compounds is/are excluded from the fabric rinse formulation.

In some embodiments, the fabric rinse formulation contains an organic acid, such as citric acid, acetic acid, or a combination thereof. The organic acid may be present in an amount of about, for example, 1, 5, 10, 20, 25, 30, 40, or 50 wt % of the fabric rinse formulation, or an amount within a range bounded by any two of the foregoing values.

In some embodiments, the fabric rinse formulation contains sodium formate. The sodium formate may be present in an amount of about, for example, 0.5, 1, 1.5, 2, or 2.5 wt % of the fabric rinse formulation, or an amount within a range bounded by any two of the foregoing values.

In some embodiments, the fabric rinse formulation contains an amine other than an amino acid, such as monoethanolamine (MEA). In other embodiments, an amine other than an amino acid is excluded, or MEA is specifically excluded.

### Unitized Format

In some embodiments, the fabric rinse formulation of the present disclosure can be in a unitized (unit dose) format, which is typically encapsulated in a container that is made from a water-soluble polymer or water-dispersible polymer. In other embodiments, the fabric rinse formulation of the present disclosure is not encapsulated in a container and is used in liquid form without any water-soluble or water-dispersible container. In some embodiments, the unitized format contains a concentrated form of the fabric rinse formulation, which may contain up to or less than 30%, 25%, 20%, 15%, or 10% water.

The container that can be used includes a water-soluble or water-dispersible polymer film, which encloses a pre-determined dose of the fabric rinse formulation of the present disclosure. The container can be in any desirable shape and size, e.g., square, rectangular, oval, elliptoid, super-elliptical, or circular shape. The unit dose container can contain more than one chamber. In such embodiments, at least one of the chambers of the unit dose containing contains the unit dose fabric treatment product of the present disclosure.

The pre-determined dose of the fabric rinse formulation is an amount that can be used in laundering of fabrics to provide chlorine scavenging, malodor reduction/elimination, and optionally, to impart scent (i.e., apply fragrance to) to a fabric or textile. In one example, the pre-determined dose is from about 0.001 g to about 1 kg per treatment.

Non-limiting examples of water-soluble or water-dispersible polymers include polyvinyl alcohol, cellulose ethers, polyethylene oxide, starch, polyvinylpyrrolidone, polyacrylamide, polyacrylonitrile, polyvinyl methyl ether-maleic anhydride, polymaleic anhydride, styrene maleic anhydride, hydroxyethylcellulose, methylcellulose, polyethylene glycol, carboxymethylcellulose, polyacrylic acid salts, alginates, acrylamide copolymers, guar gum, casein, ethylene-maleic anhydride resins, polyethyleneimine, ethyl hydroxyethylcellulose, ethyl methylcellulose, hydroxyethyl methylcellulose, film forming cellulosic polymer, polyanhydride, polysaccharide, polyalkylene oxide, cellulose, cellulose ester, cellulose amide, polyvinyl acetate, polycarboxylic acid and salt, polyaminoacid, polyamide, natural gums, polyacrylate, water-soluble acrylate copolymer, methylcellulose, carboxymethylcellulose sodium, dextrin, ethylcellulose, maltodextrin, polymethacrylate, polyvinyl alcohol copolymer, and combinations thereof.

In some embodiments, the water-soluble or water-dispersible polymer may be polyvinyl alcohol, polyvinyl acetate, film forming cellulosic polymer, polyacrylic acid, polyacrylamide, polyanhydride, polysaccharide, or a mixture thereof. In one example, the water-soluble or water-dispersible film material is polyvinyl alcohol or polyvinyl acetate. In another example, the water-soluble or water-dispersible polymer is made from a lower molecular weight water-soluble polyvinyl alcohol film-forming resin.

In some embodiments, the water-soluble or water-dispersible container can further contain a cross-linking agent. In one embodiment, the cross-linking agent can be boric acid or sodium borate.

The film material that provides the container in the unitized embodiment can have a thickness of between about 50 microns to about 120 microns, with a thickness between about 60 microns to about 100 microns being more typical.

The water-soluble or water-dispersible container can be prepared by any suitable method, such as via molding, casting, extruding or blowing, and is then filled using an automated filling process, as known in the prior art.

### Methods of Preparation

In another aspect, the present disclosure is directed to a method of making the fabric rinse formulation. Generally, selected amounts of the amino acid and one or more fabric specific agents or optional agents, such as any of those described above, and optionally, one or more pH adjusters, are homogeneously mixed with water to provide a homogeneous solution corresponding to the fabric rinse formulation. The water is preferably deionized water. The amount of amino acid may be any of the amounts or ranges thereof provided earlier above. The components may be added to the water sequentially or simultaneously. Alternatively, two or more aqueous solutions may first be produced and then combined. For example, an aqueous solution of the amino acid may be produced, an aqueous solution of at least one fabric specific agent or pH adjuster may be produced, an aqueous solution of a pH adjuster may be produced, and the resulting solutions combined.

Unitized forms may also be produced by methods well known in the art. In some embodiments, the method includes determining a pre-determined dose of the fabric rinse formulation and thereafter encapsulating the pre-determined dose in a water-soluble or water-dispersible container.

### Methods of Use

In one aspect, the fabric rinse formulation of the present disclosure can be used to scavenge chlorine to mitigate or prevent dye deterioration. The fabric rinse formulation may also reduce or eliminate malodor in fabrics. Typically, fabrics are washed and optionally undergo a fabric softening treatment, after which the fabrics are brought into contact with the fabric rinse formulation of the present disclosure. In some embodiments, after the fabrics are washed and optionally rinsed with water by conventional means, a fabric softening step is omitted and replaced with a rinsing step in which the fabric rinse formulation, as described above, is contacted with the fabrics. Typically, the fabric rinse formulation, as described above, which may be in a concentrated form, is contacted with the fabrics by first mixing a selected amount of the rinse formulation, as described above, in water to form a fabric rinse solution. The fabrics are then contacted with the fabric rinse solution. Any of the fabric rinse formulations described above may be considered to be a concentrate that can be appropriately diluted to provide a final fabric rinse solution. In some embodiments, the fabric rinse formulation may not include a fabric specific agent, and thus, may contain, at minimum, an amino acid optionally admixed with water.

The fabric rinse formulation (unitized or non-unitized format) of the present disclosure can be used to treat fabrics or textiles, for example, to provide chlorine scavenging and malodor reduction/elimination, and, in some embodiments, to impart scent (i.e., apply fragrance to) to a fabric or textile. In some embodiments, the rinse aid formulation can be used in the washing cycle or subsequent softening cycle of a laundry or fabric cleaning method to scavenge chlorine. By scavenging chlorine from the washing cycle, dye deterioration can be reduced or even eliminated. Further, the amino acid (e.g., lysine) may act as an anionic scavenger (on residual LAS from wash phase) to prevent formation of residues on fabrics.

The fabric rinse formulation (unitized or non-unitized format) can be used in a top loading or front loading washer, in hot, warm, or cold water. The fabric rinse formulation can be used with a detergent in a wash cycle, or separately but in conjunction with a detergent (for example, in a separate wash or rinse cycle). The textile, after being treated with the fabric rinse formulation, can be further processed by, for example, drying, pressing, ironing, steaming, coloring, or sewing.

### Exemplary Formulations

Formulations (abbreviated as Formula) are set forth in Table 1 below.

TABLE 1

| | Formula | Formula | Formula | Formula | Formula | Formula | Formula | Formula |
|---|---|---|---|---|---|---|---|---|
| Ingredient | 1 | 2 | 3 | 4 | 5 | 6 | 7 | 8 |
| 50% Citric Acid | 46.85 | 46.85 | 46.85 | | | 1 | 1 | 1 |
| Solution | | | | | | | | |
| 14.7% Acetic | 0 | 0 | 0 | | | | | |
| Acid Solution | | | | | | | | |
| 30% Sodium | 0.5 | 0.5 | 0.5 | | | | | |
| Formate Solution | | | | | | | | |
| 50% Sodium | 3 | 3 | 3 | | | | | |
| Hydroxide | | | | | | | | |
| Propylene Glycol | 5 | | | | | | | |
| Glycerin | | 7 | | | | | | |
| PEG 400 | | | 5 | | | | | |
| Sodium | 2.22 | 2.22 | 2.22 | | | | | |
| Cumensulfonate | | | | | | | | |
| 25-7 Nonionic | 2.5 | 2.5 | 2.5 | 3 | 5 | 5 | 5 | 5 |
| Alcohol | | | | | | | | |
| Ethoxylate | | | | | | | | |
| Sodium | | | | | | 10 | 15 | 20 |
| Carbonate | | | | | | | | |
| Perfume | 2 | 2 | 2 | 7 | 7 | 5 | 5 | 5 |
| Encapsulated | | | | 2 | 2 | | | |
| Fragrance | | | | | | | | |
| L-Lysine | 0.1 | 0.1 | 0.1 | 0.1 | 0.1 | 0.1 | 0.1 | 0.1 |
| Water | to 100% | to 100% | to 100% | to 100% | to 100% | to 100% | to 100% | to 100% |
| pH Target | 2.3 to 2.9 | 2.3 to 2.9 | 2.3 to 2.9 | 6 to 8 | 6 to 8 | 10.3 to 11.3 | 10.3 to 11.3 | 10.3 to 11.3 |

Formulations varying in the amount of lysine added (1.5%, 0.5%, and 0.1%) are set forth in Tables 2A and 2B below.

TABLE 2A

| | 1.5% Active Lysine | | 0.5% Active Lysine | | 0.1% Active Lysine | |
|---|---|---|---|---|---|---|
| | FORM A | FORM B | FORM C | FORM D | FORM E | FORM F |
| Water | 35.335 | 36.09813 | 36.075 | 36.21375 | 36.371 | 36.39875 |
| Lysine HCl | 0 | 0.9375 | 0 | 0.625 | 0 | 0.125 |
| Powder | | | | | | |
| Glycerin | 60.165 | 61.46438 | 61.425 | 61.66125 | 61.929 | 61.97625 |
| Lysine; 50% | 3 | 0 | 1 | 0 | 0.2 | 0 |
| Solution | | | | | | |
| IDS 34% | 1.5 | 1.5 | 1.5 | 1.5 | 1.5 | 1.5 |
| Solution | | | | | | |
| Total | 100 | 100 | 100 | 100 | 100 | 100 |
| | 4.5 | 2.4375 | 2.5 | 2.125 | 1.7 | 1.625 |
| Water Activity | 0.7052 | 0.6932 | 0.7055 | 0.696 | 0.6995 | 0.6979 |
| Viscosity | 13 | 12 | 15 | 12 | 15 | 12 |
| pH | 9.99 | 8.88 | 10.18 | 9.08 | 10.54 | 10.23 |

TABLE 2B

| Molar Equivalence | Start ppm | 15 Seconds | 1 Minute | 2 Minute |
|---|---|---|---|---|
| 0.14% NaOH | 1 | 1 | 1 | 1 |
| (Control) | | | | |
| 0.25% L-Lysine | 1 | 0 | 0 | 0 |
| 0.1% MEA | 1 | 0 | 0 | 0 |
| 0.14% NaOH | 3 | 3 | 3 | 3 |
| (Control) | | | | |
| 0.25% L-Lysine | 3 | 0 | 0 | 0 |
| 0.1% MEA | 3 | 1 | 1 | 1 |

The target dose of detergent per wash is approximately 45 grams and the estimated amount of water in a high efficiency washing machine is 31.4 L. Proportionally, 1.4 grams of each formula will go into 1 L of water (benchtop scale) at the disclosed ppm level of hypochlorite. The above formulas were created by adding the stated level of active material (NaOH, L-lysine, or MEA) and then adjusting the pH to 8 with citric acid or sodium hydroxide. Each of the active materials were equivalent on a molar basis. These results demonstrate that L-lysine is an effective chlorine scavenger and can outperform monoethanolamine (MEA) on a molar basis.

Further results are shown below in Table 3 below.

TABLE 3

| | Start ppm | 15 Seconds | 30 Seconds | 1 Minute | 2 min |
|---|---|---|---|---|---|
| Control | 3 | 2 | 1.5 | 1 | 1 |
| (FORM F, | | | | | |
| no Lysine) | | | | | |
| Inventive | 3 | 0 | 0 | 0 | 0 |
| FORM E | | | | | |
| (Contains | | | | | |
| Lysine HCl) | | | | | |

While the present disclosure has been particularly shown and described with respect to preferred embodiments thereof, it will be understood by those skilled in the art that the foregoing and other changes in forms and details may be made without departing from the spirit and scope of the present disclosure. It is therefore intended that the present disclosure not be limited to the exact forms and details described and illustrated, but fall within the scope of the appended claims.

What is claimed is:

1. A fabric rinse formulation comprising an amino acid in aqueous solution, wherein the fabric rinse formulation has a pH of 2-11.5.

2. The formulation of claim 1, wherein the fabric rinse formulation has a pH of 2.3-2.9.

3. The formulation of claim 2, further comprising a fabric conditioning agent.

4. The formulation of claim 2, the formulation comprising an amino acid, an acid, and water.

5. The formulation of claim 2, further comprising at least one of a surfactant and fragrance.

6. The formulation of claim 2, wherein the amino acid is selected from the group consisting of alanine, arginine, asparagine, aspartate, cysteine, glutamine, glutamate, glycine, histidine, isoleucine, leucine, lysine, methionine, phenylalanine, proline, serine, threonine, tryptophan, tyrosine, valine, unnatural amino acids, and combinations thereof.

7. The formulation of claim 1, wherein the amino acid is lysine.

8. The formulation of claim 1, wherein the fabric rinse formulation has a pH of 6 to 8.

9. The formulation of claim 8, further comprising a fabric conditioning agent.

10. The formulation of claim 8, the formulation comprising an amino acid and water.

11. The formulation of claim 8, further comprising at least one of a surfactant and fragrance.

12. The formulation of claim 8, wherein the amino acid is selected from the group consisting of alanine, arginine, asparagine, aspartate, cysteine, glutamine, glutamate, glycine, histidine, isoleucine, leucine, lysine, methionine, phenylalanine, proline, serine, threonine, tryptophan, tyrosine, valine, unnatural amino acids, and combinations thereof.

13. The formulation of claim 8, wherein the amino acid is lysine.

14. The formulation of claim 1, wherein the fabric rinse formulation has a pH of 10.3 to 11.3.

15. The formulation of claim 14, further comprising a fabric conditioning agent.

16. The formulation of claim 14, the formulation comprising an amino acid, a carbonate, and water.

17. The formulation of claim 14, further comprising at least one of a surfactant and fragrance.

18. The formulation of claim 14, wherein the amino acid is selected from the group consisting of alanine, arginine, asparagine, aspartate, cysteine, glutamine, glutamate, glycine, histidine, isoleucine, leucine, lysine, methionine, phenylalanine, proline, serine, threonine, tryptophan, tyrosine, valine, unnatural amino acids, and combinations thereof.

19. The formulation of claim 14, wherein the amino acid is lysine.

20. A method of washing a fabric, the method comprising washing the fabric with detergent followed by rinsing the washed fabric with a fabric rinse formulation comprising an amino acid in aqueous solution.
